(19) United States
(12) Patent Application Publication
(10) Pub. No.: US 2015/0081424 A1
(43) Pub. Date: Mar. 19, 2015

(54) ITEM BUNDLE DETERMINATION USING TRANSACTION DATA

(71) Applicant: International Business Machines Corporation, Armonk, NY (US)

(72) Inventors: Benjamin Letham, Cambridge, MA (US); Pavankumar Murali, Haverstraw, NY (US); Anshul Sheopuri, White Plains, NY (US); Wei Sun, Tarrytown, NY (US)

(21) Appl. No.: 14/339,620

(22) Filed: Jul. 24, 2014

Related U.S. Application Data
(60) Provisional application No. 61/879,279, filed on Sep. 18, 2013.

(51) Int. Cl. G06Q 30/02

(52) U.S. Cl. CPC G06Q 30/0247; G06Q 30/0276
USPC 705/14.46

(57) ABSTRACT

A method includes obtaining transaction data for two or more items, determining valuations for the two or more items, grouping the two or more items into one or more bundles, wherein each bundle comprises a different combination of the two or more items, estimating a joint distribution of valuations for the two or more items in each of the one or more bundles based on the transaction data for the two or more items, and estimating expected profits for each of the one or more bundles over a range of bundle prices from the joint distribution.

### CROSS-REFERENCE TO RELATED APPLICATION

The present application claims the benefit of U.S. Provisional Application No. 61/879,279, filed Sep. 18, 2013, and entitled “Method and System to Estimate Price Elasticity of Product Groups”, the disclosure of which is incorporated by reference herein.

### FIELD

The present application relates generally to item bundling and, more particularly, to techniques for determining item bundling and bundle pricing using a joint distribution computed over given transaction data.

### BACKGROUND

Item bundles generally refer to a collection of items that are sold together at a discounted price. Bundle discounts are typically offered by retailers in many industries. Theoretical and empirical work has shown that introducing an appropriately priced bundle can significantly increase profits, with low risks to the retailer.

The economic efficiency of bundling and how bundling can be used for price discrimination has been extensively examined. These foundational studies have been extended in many directions. Focus has been on analytical solutions for the optimal bundle price and other quantities of interest. These analytical results were obtained for the special case of uniformly distributed valuations, with the distributions for items in the bundle being either independent or perfectly correlated. Others have obtained some analytical results and insights by assuming the joint distribution to be bivariate normal. Still others have obtained results for a finite collection of deterministic valuations.

A number of useful insights can be gained from these simplified models. However, most of these approaches assume a known joint distribution. When working with certain types of data, such strong assumptions about the joint distribution, particularly independence, may no longer be appropriate. Even though some models eschew independence assumptions and use a methodology based in utility theory to measure valuations, their measurement procedure requires offering the bundle at various prices to elicit the demand function for the bundle. Bundle pricing without distributional assumptions for valuations has also been studied, by mailing out questionnaires that directly asked consumers for their valuations. Conjoint analysis has also been used to estimate the valuation distribution from questionnaire data in the context of bundling.

### SUMMARY

Embodiments of the invention provide techniques for determining item bundles and bundle pricing using joint distribution and transaction data.

For example, in one embodiment of the invention, a method comprises steps of obtaining transaction data for two or more items, determining valuations for the two or more items, grouping the two or more items into one or more bundles, wherein each bundle comprises a different combination of the two or more items, estimating a joint distribution of valuations for the two or more items in each of the one or more bundles based on the transaction data for the two or more items, and estimating expected profits for each of the one or more bundles over a range of bundle prices from the joint distribution.

In additional embodiments, an article of manufacture comprises a computer readable storage medium for storing computer readable program code. The computer readable program code, when executed, causes a computer to obtain transaction data for two or more items, determine valuations for the two or more items, group the two or more items into one or more bundles, wherein each bundle comprises a different combination of the two or more items, estimate a joint distribution of valuations for the two or more items in each of the one or more bundles based on the transaction data for the two or more items, and estimate expected profits for each of the one or more bundles over a range of bundle prices from the joint distribution.

In further embodiments, an apparatus comprises a memory and a processor operatively coupled to the memory. The processor is configured to obtain transaction data for two or more items, determine valuations for the two or more items, group the two or more items into one or more bundles, wherein each bundle comprises a different combination of the two or more items, estimate a joint distribution of valuations for the two or more items in each of the one or more bundles based on the transaction data for the two or more items, and estimate expected profits for each of the one or more bundles over a range of bundle prices from the joint distribution.

Advantageously, illustrative embodiments of the invention use retail transaction data to develop a statistically consistent and computationally tractable inference procedure for estimating profit as a function of bundle price. Furthermore, illustrative embodiments of the invention find bundle prices that maximize profit, but do not require unreasonable assumptions, such as independent marginal distributions. Still further, illustrative embodiments of the invention predict/estimate bundle profits without imposing restrictive valuations on the joint distribution.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 depicts an overview of a bundle pricing methodology according to an embodiment of the invention.

FIG. 2A depicts a methodology for determining bundle pricing according to an embodiment of the invention.

FIG. 2B depicts an example of the methodology of FIG. 2A.

FIG. 3 depicts an exemplary application of a rationality assumption according to an embodiment of the invention.

FIG. 4 depicts an example of bundle pricing according to an embodiment of the invention.

FIG. 5 depicts a computer system in accordance with which one or more components/steps of techniques of the invention may be implemented according to an embodiment of the invention.

### DETAILED DESCRIPTION

As illustratively used herein, the term “item” refers to goods (e.g., electronics, computer hardware or software, food and beverage etc.) and/or services (e.g., Internet service, cable service, insurance policy, etc.).

As illustratively used herein, the term “user” refers to a person or entity (e.g., retailer, sales person, marketing department, etc.).

As illustratively used herein, the phrase “transaction data” refers to data having two components: purchase data and price data.

As illustratively used herein, the term “bundle” refers to a grouping of two or more items.

As illustratively used herein, the term “valuation” refers to the price consumers are willing to pay for each item in a bundle.

As illustratively used herein, the phrase “valuation distribution” refers to the joint distribution of the valuations for the items.

As illustratively used herein, the phrase “joint distribution” refers to the relationship between two or more events.

Optimal bundle pricing involves learning the joint distribution of consumer valuations for the items in the bundle, that is, how much they are willing to pay for each of the items. Embodiments of the present invention provide an inference procedure for predicting the expected change in profits when a bundle is offered at a particular price. The procedure is developed for sales transaction data, and does not require collecting sales data for the bundle a priori, nor does it require direct elicitation of valuations via questionnaires. The procedure is based on inference of a copula model over latent consumer valuations, which allows for arbitrary marginal distributions and does not assume independence. As the valuations are unobserved, the likelihood function involves integrating over the latent valuations, and standard formulas for copula fitting cannot be directly applied. A process for transforming these computationally intractable integrals into distribution function evaluations to allow for efficient estimation will be discussed in further detail below.

1. Copula Inference and Bundle Pricing

Embodiments of the present invention introduce a procedure for learning the joint distribution of valuations from individual item sales transaction data, thus allowing for optimal bundle pricing.

Embodiments of the present invention assume that a collection of n items have been selected as a candidate bundle, n being a number greater than or equal to two. The selection of the n items can be performed by a user, by the system according to pre-defined constraints, or any other suitable methods. The objective is to determine the optimal price and its associated profit if the bundle were to be introduced. The type of bundle considered in embodiments of the present invention is known as mixed bundling, in which consumers are offered both the bundle and the individual items, with the bundle discounted relative to the sum of the item prices. It is also assumed that the items have not previously been offered as a bundle, but historical sales transaction data are available for the individual items.

Even if a bundle has not been previously offered, useful information about how to price the bundle can be obtained from the sales history of the individual items included in the bundle. Choosing the optimal bundle price relies critically on a knowledge of the price consumers are willing to pay for each item in the bundle, called their valuations, as well as the interplay between the valuations of items in the bundle. A retailer generally does not know the full, joint distribution of valuations. However, the retailer likely does have historical sales transaction data for the individual items.

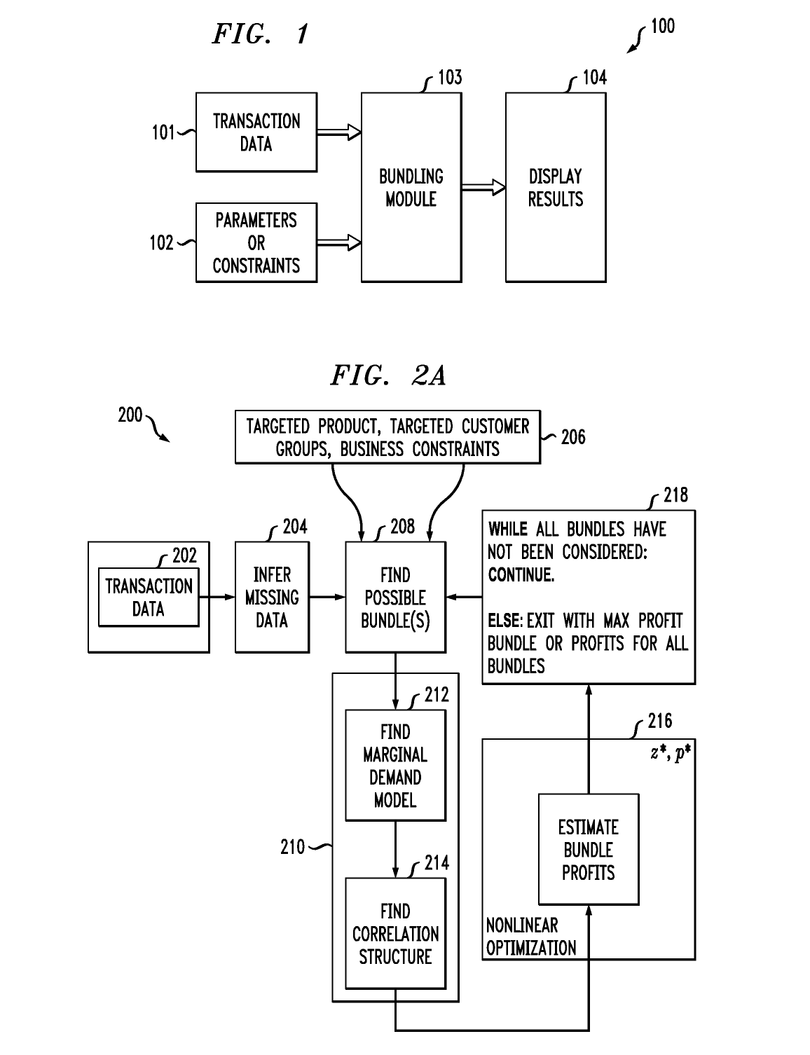

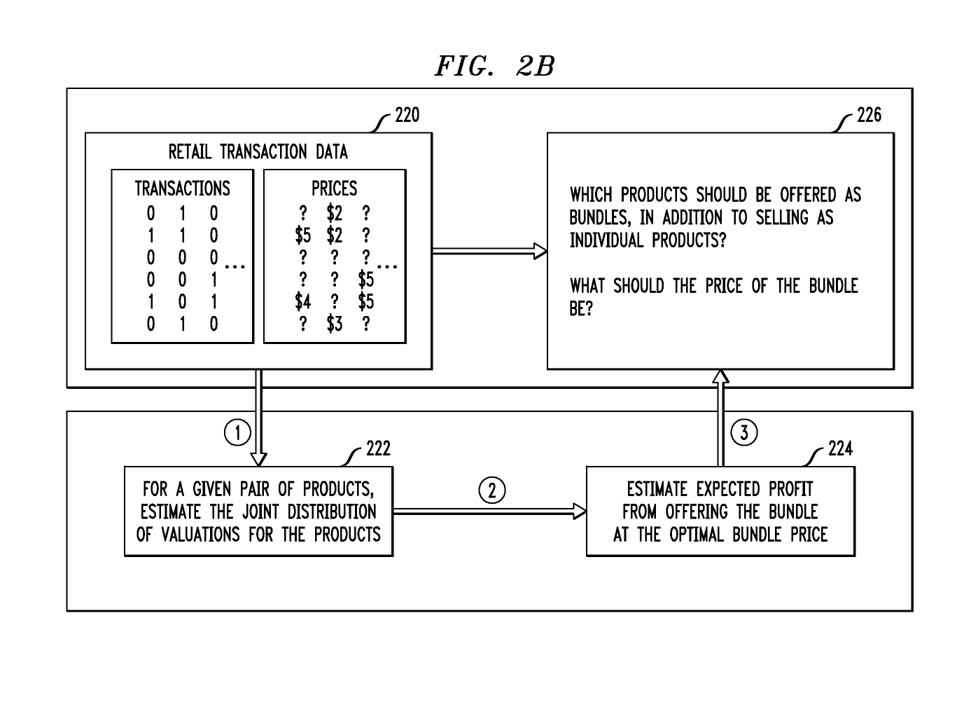

FIG. 1 illustrates an overview of a bundle pricing methodology according to an embodiment of the invention. As shown, methodology 100 includes obtaining transaction data for the n items that are potential candidates for bundling at step 101 and obtaining parameters or constraints (e.g., business constraints, targeted product groups and targeted customer groups) for the potential bundles at step 102. These parameters or constraints can be determined by a user or they can be pre-defined in the system. The transaction data and parameters or constraints are then used as inputs for the bundling module at step 103. The methodology and steps of bundling module 103 will be described in detail with regards to FIG. 2A and FIG. 2B. The results from bundling module 103 are then displayed at step 104. The results can be displayed as a graph showing the expected profit of each bundle across a range of bundle discounts or prices. Alternatively, an optimal bundle price for each bundle can be displayed to the user. The user may choose to see the results as a graph, an optimal bundle price, or a combination of both.

FIG. 2A illustrates a flow chart of a methodology for implementing the bundling module of step 103 in FIG. 1. Methodology 200 starts at step 202 with the transaction data obtained in step 101 of FIG. 1. At step 204, data that is missing from the transaction data is inferred. The data might be missing for various reasons, for example, the consumer did not buy the product during that transaction. Missing data can be inferred from historical transaction data. At step 206, the parameters or constraints obtained in step 102 of FIG. 1 are used along with the transaction data to find possible bundle(s) at step 208. At step 210, the bundling module finds the joint valuation distribution for the items. Step 210 includes finding a marginal demand model for the two or more items at step 212 and finding a correlation structure for the two or more items at step 214. Then at step 216, bundle profits are estimated using non-linear optimization. At step 218, a determination is made as to whether or not all bundles have been considered: if all bundles have been considered, the program exits with the maximum profit bundle or with profits for multiple bundles; if not, then the methodology returns to step 208 to find more possible bundle(s).

Transaction data refers to data having two components: purchase data y^{t} and price data x^{t}. Specifically, y^{t}=[y₁^{t}, . . . , yₙ^{t}] denotes the sales data for transaction t, with yᵢ^{t}=1 if item i was purchased in transaction t, and 0 otherwise. It is assumed that the price of each item at the time of each transaction is known, and the price of item i at the time of transaction t is denoted as xᵢ^{t}. For simplicity, it is assumed that for each day there was a single price for each item. If there were multiple prices at which an item was sold on a given day, that day's price can be taken as the median of the observed prices. If an item was not sold on a particular day, then that day's price can be taken as the price of the preceding day or the average of the item for a specific period of time. Let T denote the total number of transactions.

FIG. 2B illustrates an example application of the methodology of FIG. 2A. In this example, the user is interested in obtaining the optimal bundle price for one or more bundles of products. The products in each bundle can be selected by the user or selected based on constraints/parameters set by the user. The user is interested in using retail transaction data for the products to assess which products should be offered as bundles, in addition to selling as individual products, and how the bundles should be priced. That is, to get from step 220 to step 226, the methodology starts at step 220 with retail transaction data. Retail transaction data includes a transactions matrix showing sales data y^{t}=[y₁^{t}, . . . , yₙ^{t}] for transaction t, each row of the transactions matrix represents a transaction and each column of the matrix represents a product. The retail transaction data also includes a price matrix with corresponding price information xᵢ^{t} for the respective transactions and products of the transactions matrix. The missing data that may be inferred in step 204 of FIG. 2A are shown as question marks in the price matrix of the retail transaction data at step 220. The missing data may be inferred using historical transaction data. For example, the question mark representing the price associated with a product may be inferred as the most observed price for the product on the date of interest or the average price of the product for a specific period of time. Then at step 222, which corresponds to steps 208 to 214 of FIG. 2A, the retail transaction data is used to estimate the joint distribution of valuations for one or more pairs of products. At step 224, which corresponds to step 216 of FIG. 2A, the expected profit from offering the bundle of products at the optimal bundle price is estimated for one or more bundles. Then at step 226, the estimated optimal bundle price for each bundle is shown to the user for use in determining which products should be offered as bundles, in addition to selling as individual products, and how the bundle should be priced.

### 2.1 Valuations and Consumer Rationality

Embodiments of the present invention also assume that each consumer has a valuation for each item, with vᵢ^{t} representing the (unobserved) valuation for item i by the consumer in transaction t. Embodiments of the present invention assume that consumers are rational, i.e. a customer purchases item i if and only if his or her valuation of product i is larger than its price.

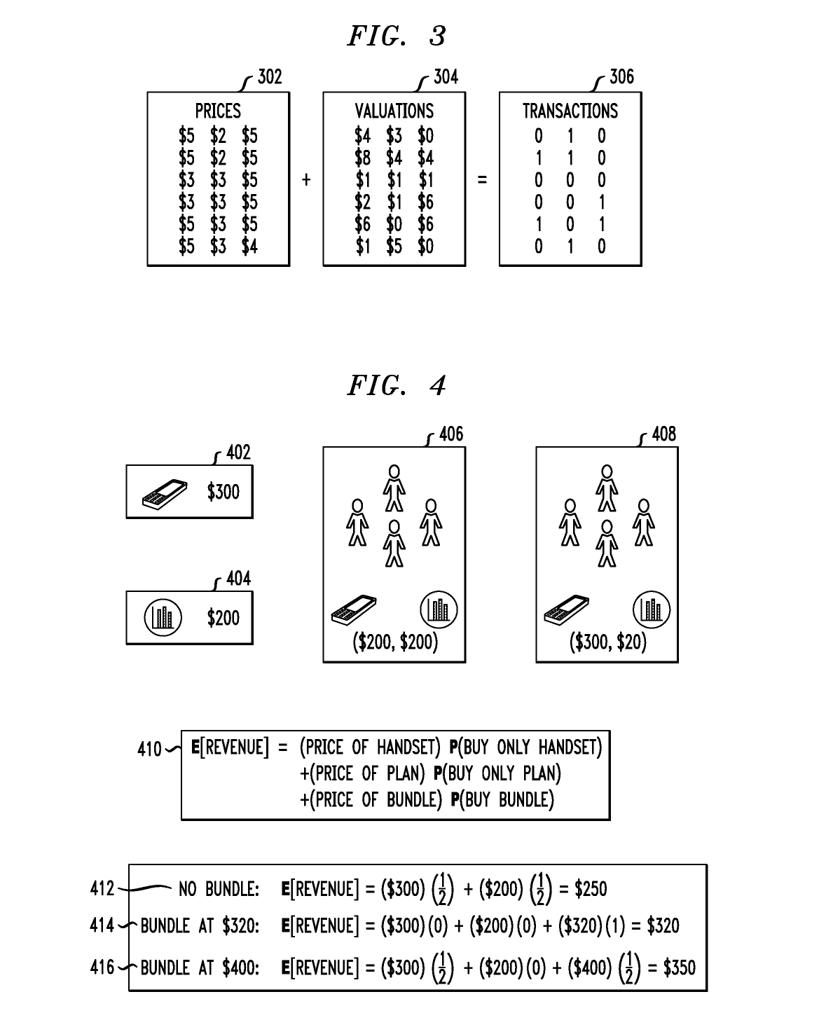

FIG. 3 illustrates this rationality assumption. Block 302 shows a matrix of prices for n items, and block 304 shows a matrix of consumer valuations for the n items. In both block 302 and block 304, each column of the matrices represents a different item and each row of the matrices represents a different transaction with a consumer. For example, for an electronics retailer, the first column can represent the price or valuation of a camera, the second column can represent the price or valuation of a memory card suitable for use with the camera, and the third column can represent the price or valuation of a tripod suitable for use with the camera. As shown in block 306, when the valuation of the item is greater than the price of the item, the transaction is successful as indicated by a “1” and if the valuation of the item is less than the price of the item, the transaction fails and is indicated by a “0”.

Consumers are further modeled as having infinite budget, and as purchasing the assortment of items that maximizes the total difference between their valuation and the price:

$${y}^{t} ∈ {arg max}_{y ∈ {\{ 0 , 1 \}}^{n}} {\sum }_{i = 1}^{n} ( {υ}_{i}^{t} - {x}_{i}^{t} ) {y}_{i} . \qquad ( 1 )$$

The rationality assumption implies that yᵢ^{t}=1 if and only if vᵢ^{t}>xᵢ^{t}. However, vᵢ^{t} is modeled as a continuous random variable, and the model does not devote attention to the case in which vᵢ^{t}=xᵢ^{t}.

The rationality assumption provides a model for the relationship between valuations vᵢ^{t} and transaction data yᵢ^{t} and xᵢ^{t}. Using this model, likelihood formulas for inferring a joint distribution of valuations from sales transaction data can be derived and the valuation distribution can be used to find the optimal bundle price.

### 2.2 Joint Distribution Models and Copula Inference

To implement step 210 of FIG. 2A, the bundling module estimates the joint distribution of valuations for the items. The most straightforward approach to model a joint distribution is to assume independence. This type of joint model allows for arbitrary margins, however independence is a potentially unreasonable assumption, especially because correlations are quite important for bundling. Modeling the joint distribution as a multivariate normal allows for correlations via a covariance matrix, however it requires the margins to be normally distributed, which can also be a strong assumption when learning from data. Embodiments of the present invention model the joint distribution using a copula model, which is a class of joint distributions that allows for both correlation structures and arbitrary margins.

Embodiments of the present invention assume that consumers are homogeneous, and model the consumer valuations v^{t} as independent draws from a joint distribution with distribution function F(v₁, . . . , vₙ). The objective is to infer this joint distribution. Let Fᵢ(vᵢ) be the marginal distribution function for item i. Then, a copula [symbol] (•) for F(•) is a distribution function over [0,1]ⁿ with uniform margins such that

F(v₁, . . . , vₙ)= [symbol] (F₁(v₁), . . . , Fₙ(vₙ)).

The copula combines the margins in such a way as to return the joint distribution. A copula allows for the correlation structure to be modeled separately from the marginal distributions, in a specific way which will be shown below. The field of copula modeling is based on a representation theorem which shows that every distribution has a copula, and if the margins are continuous, the copula is unique.

The present approach to estimating F(•) is to choose parametric forms for the margins Fᵢ(•) and the copula [symbol] (•), and then find the parameters for which [symbol] (F₁(v₁), . . . , Fₙ(vₙ)) is closest to F(v₁, . . . , vₙ), in a likelihood sense. Specifically, suppose each margin is a distribution function with parameters θᵢ, and the copula distribution belongs to a family with parameters φ. The parameterized margins are denoted as Fᵢ(vᵢ;θᵢ) and the parameterized joint distribution as F(v;θ,φ)= [symbol] (F₁(v₁;θ₁), . . . , Fₙ(vₙ;θₙ);φ). The maximum likelihood problem is represented as:

$$( {\hat{θ}}_{ML} , {\hat{φ}}_{ML} ) ∈ {arg max }_{θ , φ} 𝓁 ( θ , φ ) ,$$

where l(θ,φ) is the appropriate log-likelihood function.

The main advantage in using a copula model is that the parameters can be separated into those that are specific to one margin (θᵢ) and those that are common to all margins (φ). Using a procedure called inference functions for margins (IFM), the optimization can be performed in two steps. First each margin is fit independently, and then the margin estimates are used to fit the correlation structure:

$$\begin{matrix}{\hat{θ}}_{i} ∈ {arg max}_{{θ}_{i}} {𝓁}_{i} ( {θ}_{i} ) , i = 1 , … , n & ( 2 ) \\ \hat{φ} ∈ {arg max}_{φ} 𝓁 ( \hat{θ} , φ ) . & ( 3 )\end{matrix}$$

This gives computational tractability by significantly reducing the dimensionality of the optimization problem that must be solved. In general, IFM does not yield exactly the maximum likelihood estimate: (\hat{θ}_{ML},\hat{φ}_{ML})≠(\hat{θ},\hat{φ}). However, the IFM estimates (\hat{θ},\hat{φ}), like the maximum likelihood estimates, are statistically consistent and asymptotically normal.

The inference problem here differs from a typical copula modeling problem because the distribution of interest here is that over valuations, which are unobserved latent variables. In the next two sections, the rationality assumption of (1) is used to derive tractable likelihood formulas to be used in (2) and (3).

### 2.3 Margin Likelihood and Demand Models

As part of the process of implementing step 210 of FIG. 2A, the bundling module further finds a marginal demand model at step 212 as follows.

First, consider the margin maximum likelihood problem in (2). Let pᵢ(xᵢ^{t}) be the probability of purchase for item i at price xᵢ^{t}, that is, the demand model for item i. The following proposition shows an equivalence between the marginal valuation distribution function and demand models.

It is to be appreciated that the demand function and the inverse marginal valuation distribution function are identical, i.e.

pᵢ(xᵢ^{t})=1−Fᵢ(xᵢ^{t};θᵢ).

The following likelihood model is chosen for the observed purchase data:

yᵢ^{t}˜Bernoulli(1−Fᵢ(xᵢ^{t};θᵢ).

Given data {xᵢ^{t},yᵢ^{t}}ᵢ₌₁^{T}, the log-likelihood function for each margin is:

$${𝓁}_{i} ( {θ}_{i} ) = {\sum }_{t = 1}^{T} ( {y}_{i}^{t} log ( 1 - {F}_{i} ( {x}_{i}^{t} ; {θ}_{i} ) ) + ( 1 - {y}_{i}^{t} ) log ( {F}_{i} ( {x}_{i}^{t} ; {θ}_{i} ) ) ) . \qquad ( 4 )$$

If Fᵢ(•;θᵢ) is linear in θᵢ, for example when using a linear demand model, then the maximum likelihood problem is a concave maximization. For general demand models, a local maximum can easily be found using standard optimization techniques. Section 2.7 below discloses some possible choices for the family of Fᵢ(•;θᵢ).

### 2.4 Copula Inference Over Latent Variables

As yet another part of the process of implementing step 210 of FIG. 2A, the bundling module finds a correlation structure at step 214 as follows.

Once the margin parameters \hat{θ}ᵢ have been estimated by maximizing (4), these estimates are used, together with the data, to obtain an estimate of the copula parameters φ. An expression for the log-likelihood of φ can now be derived:

$$\begin{matrix}𝓁 ( \hat{θ} , φ ) = {\sum }_{t = 1}^{T} log p ( {y}^{t} \vert {x}^{t} , \hat{θ} , φ ) \\ = {\sum }_{t = 1}^{T} log \int p ( {y}^{t} \vert {υ}^{t} , {x}^{t} , \hat{θ} , φ ) p ( {y}^{t} \vert {x}^{t} , \hat{θ} , φ ) d {υ}^{t} .\end{matrix} \qquad ( 5 )$$

Given v^{t} and x^{t}, y^{t} is deterministic, with yᵢ^{t}=1 if vᵢ^{t}>xᵢ^{t} and 0 otherwise. Thus the integral over v^{t} can be limited to all v^{t} that are consistent with y^{t} and x^{t}, meaning the integral is over vᵢ^{t}>xᵢ^{t} for i such that yᵢ^{t}=1, and over vᵢ^{t}≦xᵢ^{t} for i such that yᵢ^{t}=0. The lower and upper limits of integration are then defined as,

$${υ}_{i}^{t , 𝓁} = \{ \begin{matrix}- ∞ & if {y}_{i}^{t} = 0 , \\ {x}_{i}^{t} & if {y}_{i}^{t} = 1 ,\end{matrix} and {υ}_{i}^{t , u} = \{ \begin{matrix}{x}_{i}^{t} & if {y}_{i}^{t} = 0 , \\ + ∞ & if {y}_{i}^{t} = 1.\end{matrix}$$

The quantity p(v^{t}|x^{t},\hat{θ},φ)=p(v^{t}|\hat{θ},φ) is exactly the copula density function, which is denoted as ƒ(•;\hat{θ},φ). Continuing the likelihood expression from (5),

$$𝓁 ( \hat{θ} , φ ) = {\sum }_{t = 1}^{T} log {\int }_{{υ}_{n}^{t , 𝓁}}^{{υ}_{n}^{t , u}} … {\int }_{{υ}_{1}^{t , 𝓁}}^{{υ}_{n}^{t , u}} f ( {υ}_{1}^{t} , … , {υ}_{n}^{t} ; \hat{θ} , φ ) d {υ}_{1}^{t} … d {υ}_{n}^{t} . \qquad ( 6 )$$

The integral in (6) renders the likelihood formula intractable. To allow for efficient inference, the following formula for a rectangular integral of a probability density function will be used. This formula is critical to the scalability of the inference procedure as it allows for replacement of the multidimensional integral in (6) with distribution function evaluations.

The log-likelihood expression in (6) can now be evaluated:

$$𝓁 ( \hat{θ} , φ ) = {\sum }_{t = 1}^{T} log {\sum }_{k = 0}^{n} {( - 1 )}^{k} {\sum }_{{I ⊆ \{ 1 , … n \}}_{\vert I \vert = k}}^{ } F ( {\tilde{υ}}^{t} ( I ) ; \hat{θ} , φ ) , \\ whereas before \\ {\tilde{υ}}_{i}^{t} ( I ) = \{ \begin{matrix}{υ}_{i}^{t , 𝓁} & if i ∈ I , \\ {υ}_{i}^{t , u} & otherwise .\end{matrix} \qquad ( 7 )$$

For the simplest case of two items in a bundle, the inner expression in (7) evaluates to:

$${\sum }_{k = 0}^{2} {( - 1 )}^{k} {\sum }_{{I ⊆ \{ 1 , … n \}}_{\vert I \vert = k}}^{ } F ( {\tilde{υ}}_{1}^{t} ( I ) , {\tilde{υ}}_{2}^{t} ( I ) ) = \{ \begin{matrix}F ( {x}_{1}^{t} , {x}_{2}^{t} ) & if y = ( 0 , 0 ) , \\ {F}_{1} ( {x}_{1}^{t} ) - F ( {x}_{1}^{t} , {x}_{2}^{t} ) & if y = ( 0 , 1 ) , \\ {F}_{2} ( {x}_{2}^{t} ) - F ( {x}_{1}^{t} , {x}_{2}^{t} ) & if y = ( 1 , 0 ) , \\ 1 - {F}_{1} ( {x}_{1}^{t} ) - {F}_{2} ( {x}_{2}^{t} ) + F ( {x}_{1}^{t} , {x}_{2}^{t} ) & if y = ( 1 , 1 ) .\end{matrix}$$

### 2.5 Consistency and Scalability

Combining (4) and (7) yields the complete inference procedure, it is to be appreciated that the inference procedure:

$${\hat{θ}}_{i} ∈ {arg max}_{{θ}_{i}} {\sum }_{t = 1}^{T} ( {y}_{i}^{t} log ( 1 - {F}_{i} ( {x}_{i}^{t} ; {θ}_{i} ) ) + ( 1 - {y}_{i}^{t} ) log ( {F}_{i} ( {x}_{i}^{t} ; {θ}_{i} ) ) )$$

$$\hat{φ} ∈ {arg max}_{φ} {\sum }_{t = 1}^{T} log {\sum }_{k = 0}^{n} {( - 1 )}^{k} {\sum }_{{I ⊆ \{ 1 , … n \}}_{\vert I \vert = k}}^{ } F ( {\tilde{υ}}^{t} ( I ) ; \hat{θ} , φ )$$

is statistically consistent.

Because the inference is exactly the IFM procedure, it follows that it is statistically consistent.

The computation is exponential in the size of the bundle n, however in retail practice bundle offers generally do not contain a large number of items. Importantly, the computation is linear in the number of transactions T, which allows inference to be performed even on very large transaction databases. The main computational step is evaluating the copula distribution function in (7). For many copula models, such as the Gaussian copula which will be described below in Section 2.7, efficient techniques are available for distribution function evaluation.

### 2.6 Computing the Optimal Bundle Price

At step 216 of FIG. 2A, the bundles profits are estimated as follows. Given the joint valuation distribution, the expected profit per consumer as a function of item and bundle prices can be computed. For notational convenience, the result for n=2 is given here. Consumers are rational, in that they choose the option (item 1 only, item 2 only, bundle, or no purchase) that maximizes their surplus vᵢ−xᵢ. For this result, it is assumed that the valuation for the bundle is the sum of the component valuations v_{B}=v₁+v₂, although this could easily be relaxed to other bundle valuation models. Note that inferring the joint valuation distribution does not require any assumption on how valuations combine, rather this assumption is only used to compute the expected profit of bundling. The cost of item i is denoted as cᵢ and it is assumed that the bundle cost is the sum of the component costs.

It is to be appreciated that for joint valuation density function ƒ(•) and joint valuation distribution function F(•), the expected profit per consumer obtained when items 1, 2, and the bundle are priced at x₁, x₂, and x_{B} respectively is:

$$𝔼 [ profit ] = ( {x}_{1} - {c}_{1} ) ( {F}_{2} ( {x}_{B} - {x}_{1} ) - F ( {x}_{1} , {x}_{B} - {x}_{1} ) ) + ( {x}_{2} - {c}_{2} ) ( {F}_{1} ( {x}_{B} - {x}_{2} ) - F ( {x}_{B} - {x}_{2} , {x}_{2} ) ) + ( {x}_{B} - {c}_{1} - {c}_{2} ) ( 1 - {F}_{1} ( {x}_{B} - {x}_{2} ) - {F}_{2} ( {x}_{B} - {x}_{1} ) + F ( {x}_{B} - {x}_{2} , {x}_{B} - {x}_{1} ) - {\int }_{{x}_{B} - {x}_{2}}^{{x}_{1}} {\int }_{{x}_{B} - {x}_{1}}^{{x}_{B} - {υ}_{1}} f ( {υ}_{1} , {υ}_{2} ) d {υ}_{2} d {υ}_{1} ) .$$

Similar results, albeit notationally complex, can be obtained for n>2 . The inference procedure from Section 2.5 is used to estimate the valuation distribution function, which allows the expression E[profit] to be evaluated. Maximizing the expected profit with respect to x_{B} yields the optimal bundle price, or maximizing over x_{B} and the item prices simultaneously yields a complete pricing strategy. The formula E[profit] is not concave in general, but a local maximum can be found using standard numerical optimization techniques.

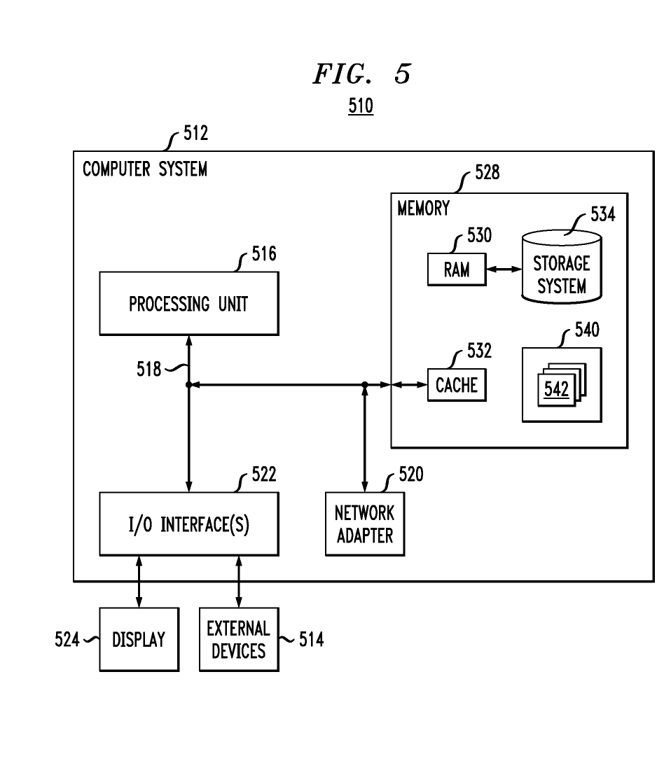

FIG. 4 illustrates an example of bundle pricing for two items (i.e. n=2) according to an embodiment of the present invention. Bundle pricing for the two items is obtained using the methodology of FIG. 2A. In this example, a wireless service provider is interested in offering the handset 402 and wireless plan 404 as a bundle and wants to find the optimal bundle price that will maximize revenue. The handset 402 is priced at $300 if sold individually, and the wireless plan 404 is priced at $200 if sold individually. These prices can be observed from retail transaction data. As show in 410, the estimated revenue is computed as the price of the handset multiplied by the probability that the consumer will buy only the handset, plus the price of the wireless plan multiplied by the probability that the consumer will buy only the wireless plan, plus the price of the bundle multiplied by the probability that the consumer will buy the bundle at the offered price. As shown in equation 412, the estimated revenue of selling the two items without bundling is $250. Whereas, as shown in equation 414 and corresponding diagram 408, when the handset 402 is held at the price of $300 and the wireless plan 404 is discounted to a price of $20 for a bundle price of $320, the estimated revenue of the bundle is $320. However, as shown in equation 416 and corresponding diagram 406, when the handset 402 is discounted to $200 and the wireless plan 404 is held at $200 for a bundle price of $400, the estimated revenue of the bundle is $350. As can be observed from the results, offering bundles at different prices can result in different profits.

The estimated revenue calculated in the above example can be displayed to the user in various ways. For example, the user may choose to see only the optimal bundle price, or the user may choose to see the estimated revenue as a graph showing the change in estimated revenue with respect to the change in bundle discount.

Though not shown in FIG. 4, for n>2, further iterations through steps 208 to 218 of FIG. 2A can be made such that all bundles having different combinations of the n items can be considered.

Discounting the bundle increases volume, but decreases revenue-per-item. The optimal balance depends on the valuation distribution, and especially on the correlations between items in the bundle. Embodiments of the invention use retail transaction data to provide estimated profits for bundles across a range of prices to give the user the optimal bundle price for maximizing profit.

### 2.7 Distributional Assumptions

The likelihood formulas in (4) and (7) hold for arbitrary margins Fᵢ(•;θᵢ) and an arbitrary copula model [symbol] (•;φ). To apply these formulas to data requires choosing the distributional form of the margins and the copula family.

The connection between marginal valuation distributions and demand models given in Proposition 1 shows that the margin distribution can naturally be selected by choosing an appropriate demand model. Many retailers already use demand models for sales forecasting, and these existing models could be directly converted to marginal valuation distributions. For example, two common choices for demand models are the linear demand model and the normal-cdf demand model. The linear demand model is:

p(xᵢ;βᵢ,ηᵢ)=min(1, max(0,βᵢ−ηᵢxᵢ)),

and the corresponding valuation distribution is uniform:

$${υ}_{i} \sim Unif ( \frac{β - 1}{η} , \frac{β}{η} ) .$$

When the demand model is the normal distribution function

p(xᵢ;μᵢσᵢ²)=1−Φ(xᵢ;μᵢ,σᵢ²),

the corresponding marginal valuation distribution is the normal distribution:

vᵢ˜ [symbol] (μᵢ,σᵢ²).

Additional covariates like competitors' prices or the prices of substitutable and complimentary products are sometimes used in demand modeling, for instance in a choice model. Seasonality effects are also often handled using covariates. Models with covariates can also be transformed into valuation distributions using the margin likelihood and demand models previously discussed in Section 2.3.

There is a large selection of copula models, which differ primarily in the types of correlation they can express. One of the most popular copula models, and that which is used in the present invention, is the Gaussian copula:

[symbol]

(F₁(v₁), . . . , Fₙ(vₙ);φ)=Φ(F₁(v₁), . . . , Fₙ(vₙ);φ),

where Φ(•;φ) represents the multivariate normal distribution function with correlation matrix φ. The Gaussian copula is in essence an extension of the multivariate normal distribution, in that it extends the multivariate normal correlation structure to arbitrary margins, as opposed to constraining the margins to be normally distributed. If a correlation matrix structure is not appropriate to model the dependencies in a particular application, then alternative copula models can be used.

Embodiments of the present invention use copula modeling in the context of an important business analytics problem, and in the process have developed new methodological results on learning a copula distribution over latent variables. Business analytics is a budding application area in machine learning, and embodiments of the present invention provide foundational results for inferring consumer valuations. The ability to predict the effect of introducing a bundle at a particular price using only historical sales data is a major advancement in data-driven pricing, and the copula model at the core of the inference here is flexible enough to be useful in real applications. As the copula allows for arbitrary margins, if a retailer has already developed demand models for a particular item, the demand model can be used directly to obtain the marginal valuation distribution. The likelihood formulas that were derived above provide a theoretically and computationally sound framework for copula learning over latent valuations. Embodiments of the present invention account for correlations in valuations when estimating the response to bundle discounts, thus applications of embodiments of the present invention to actual retail data have shown that the copula model had higher predictive likelihoods than the corresponding independence model.

Embodiments of the present invention may be a system, a method, and/or a computer program product. The computer program product may include a computer readable storage medium (or media) having computer readable program instructions thereon for causing a processor to carry out aspects of the present invention.

Accordingly, the architecture shown in FIG. 5 may be used to implement the various components/steps shown and described above in the context of FIGS. 1-4.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

One or more embodiments can make use of software running on a general-purpose computer or workstation. With reference to FIG. 5, in a computing node 510 there is a computer system/server 512, which is operational with numerous other general purpose or special purpose computing system environments or configurations. Examples of well-known computing systems, environments, and/or configurations that may be suitable for use with computer system/server 512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 512 may be described in the general context of computer system executable instructions, such as program modules, being executed by a computer system. Generally, program modules may include routines, programs, objects, components, logic, data structures, and so on that perform particular tasks or implement particular abstract data types. Computer system/server 512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 512 in computing node 510 is shown in the form of a general-purpose computing device. The components of computer system/server 512 may include, but are not limited to, one or more processors or processing units 516, a system memory 528, and a bus 518 that couples various system components including system memory 528 to processor 516.

The bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system/server 512 typically includes a variety of computer system readable media. Such media may be any available media that is accessible by computer system/server 512, and it includes both volatile and non-volatile media, removable and non-removable media.

The system memory 528 can include computer system readable media in the form of volatile memory, such as random access memory (RAM) 530 and/or cache memory 532. The computer system/server 512 may further include other removable/non-removable, volatile/nonvolatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 518 by one or more data media interfaces. As depicted and described herein, the memory 528 may include at least one program product having a set (e.g., at least one) of program modules that are configured to carry out the functions of embodiments of the invention. A program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein.

Computer system/server 512 may also communicate with one or more external devices 514 such as a keyboard, a pointing device, a display 524, etc., one or more devices that enable a user to interact with computer system/server 512, and/or any devices (e.g., network card, modem, etc.) that enable computer system/server 512 to communicate with one or more other computing devices. Such communication can occur via Input/Output (I/O) interfaces 522. Still yet, computer system/server 512 can communicate with one or more networks such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples include, but are not limited to, microcode, device drivers, redundant processing units, external disk drive arrays, RAID systems, tape drives, and data archival storage systems, etc.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method, comprising steps of:
obtaining transaction data for two or more items;
determining valuations for the two or more items;
grouping the two or more items into one or more bundles, wherein each bundle comprises a different combination of the two or more items;
estimating a joint distribution of valuations for the two or more items in each of the one or more bundles based on the transaction data for the two or more items; and
estimating expected profits for each of the one or more bundles over a range of bundle prices from the joint distribution;
wherein the steps are performed by at least one processor device coupled to a memory.

2. The method of claim 1, further comprising displaying the expected profits of each of the one or more bundles over a range of bundle prices as a graph for each of the one or more bundles.

3. The method of claim 1, further comprising displaying an optimal bundle price for each of the one or more bundles.

4. The method of claim 1, further comprising selecting a bundle and a bundle price based on the expected profits for each of the one or more bundles.

5. The method of claim 1, wherein the joint distribution is in the form of a Gaussian copula model.

6. The method of claim 5, further comprising fitting the Gaussian copula model over correlated valuations.

7. The method of claim 1, wherein the step of estimating a joint distribution further comprises generating a marginal demand model.

8. The method of claim 7, wherein the step of estimating a joint distribution further comprises generating a correlation structure for the two or more items.

9. The method of claim 7, wherein the marginal demand model is based on a rationality assumption.

10. The method of claim 8, wherein the step of generating a correlation structure for the two or more items comprises utilizing at least one likelihood computation.

11. The method of claim 1, wherein the two or more items are selected by a user.

12. The method of claim 1, wherein the two or more items are selected according to at least one constraint.

13. The method of claim 12, wherein the at least one constraint comprises targeted items, targeted consumer groups, business constraints or combinations thereof.

14. The method of claim 1, wherein the two or more items comprise goods, services or combinations thereof.

15. The method of claim 1, wherein the transaction data comprises purchase data and price data for the two or more items.

16. An apparatus comprising:
a memory; and
a processor operatively coupled to the memory and configured to:
obtain transaction data for two or more items;
determine valuations for the two or more items;
group the two or more items into one or more bundles, wherein each bundle comprises a different combination of the two or more items;
estimate a joint distribution of valuations for the two or more items in each of the one or more bundles based on the transaction data for the two or more items; and
estimate expected profits for each of the one or more bundles over a range of bundle prices from the joint distribution.

17. The apparatus of claim 16, wherein the joint distribution is in the form of a Gaussian copula model.

18. The apparatus of claim 17, further comprising fitting the Gaussian copula model over correlated valuations.

19. The apparatus of claim 16, further configured to display the expected profits of each of the one or more bundles over a range of bundle prices as a graph, an optimal bundle price, or a combination thereof for each of the one or more bundles.

20. An article of manufacture comprising a computer readable storage medium for storing computer readable program code which, when executed, causes a computer to:
obtain transaction data for two or more items;
determine valuations for the two or more items;
group the two or more items into one or more bundles, wherein each bundle comprises a different combination of the two or more items;
estimate a joint distribution of valuations for the two or more items in each of the one or more bundles based on the transaction data for the two or more items; and
estimate expected profits for each of the one or more bundles over a range of bundle prices from the joint distribution.
